(19) United States
(12) Patent Application Publication
(10) Pub. No.: US 2023/0139452 A1
(43) Pub. Date: May 4, 2023

(54) PARTIALLY SUBMERGED FOAM FRACTIONATION SYSTEM

(71) Applicant: Clean Waterways, LLC, Fort Lauderdale, FL (US)

(72) Inventors: Charles GREGORY, Fort Lauderdale, FL (US); Miles A. FORMAN, II, Fort Lauderdale, FL (US); John T. LOOS, III, Fort Lauderdale, FL (US); Shane LAFRENIERE, Fort Lauderdale, FL (US); Michael LAMBRECHTS, Fort Lauderdale, FL (US); John MILLEDGE, Fort Lauderdale, FL (US)

(21) Appl. No.: 17/975,504

(22) Filed: Oct. 27, 2022

Related U.S. Application Data
(60) Provisional application No. 63/272,813, filed on Oct. 28, 2021.

(51) Int. Cl. C02F 1/24; B01D 21/00; E02B 15/10

(52) U.S. Cl. CPC C02F 1/24; B01D 21/0084; B01D 21/0027; E02B 15/10; C02F 2103/007

(57) ABSTRACT

The present disclosure relates to devices, systems, and methods for using foam fractionation to remove non-polar waste molecules, including, but not limited to, sewage bacteria, environmental contaminants, and/or sediment/turbidity caused by dredging activities, from open-water aquatic environments. Some foam fractionation systems disclosed herein generally include a plurality of partially submerged foam fractionation devices, each foam fractionation device including a foam collection reservoir positioned above a waterline and a reaction chamber positioned at least partially below the waterline. In some embodiments, the partially submerged foam fractionation device is supported by a base structure, such as a barge, boat, skiff, or the like. In other embodiments, the partially submerged foam fractionation device is a free-floating device.

### CROSS-REFERENCE TO RELATED APPLICATIONS

This application is related to and claims the benefit of U.S. Provisional Patent Application Ser. No. 63/272,813, filed Oct. 28, 2021, entitled PARTIALLY SUBMERGED FOAM FRACTIONATION SYSTEM, the entirety of which is incorporated herein by reference.

### GOVERNMENT RIGHTS STATEMENT

N/A.

### TECHNICAL FIELD

The present disclosure relates to devices, systems, and methods using foam fractionation to remove non-polar waste molecules, including, but not limited to, sewage bacteria, environmental contaminants such as nitrogen and phosphorus, and/or sediment/turbidity caused by dredging activities, from open-water aquatic environments. The present disclosure also relates to such devices and systems that are partially submerged to reduce weight and increase treatment volume.

### INTRODUCTION

Foam fractionation is a process by which non-polar waste molecules, such as sewage bacteria, waste and/or runoff chemicals, petroleum products, and other organic compounds, are removed from water. Foam fractionators (also called protein skimmers or protein fractionators) are used in commercial applications, including municipal water treatment facilities, public aquariums, and open-water aquatic environmental systems, as well as home aquariums and in-home filtration. For example, although originally used for recuperating valuable biomedical compounds, the use of foam fractionation has become popular in the aquarium industry for polishing water to the high qualities necessary for raising fragile fish an invertebrates such as corals. In this capacity, the technology removes leftover food and animal waste from a closed system.

However, environmental trials using industrial-sized foam fractionators designed for large public aquariums, for example, not only require significant customization to integrate these machines into platforms that are environmentally durable, versatile, and deployable, but their design must also be carefully considered so these machines draw and release water safely from and to the surrounding environment. Additionally, although foam fractionators that are capable of maximizing foam fractionation for water purification are currently designed for land-based and closed-system applications, they are not configured for mobile applications, such as for temporary and/or repositionable use along canals, in ports, marinas, and/or harbors, in small inland ponds and lakes, and/or narrow and/or shallow waterways, and other locations, including for non-permanent use. Further, known foam fractionation systems are not sufficiently scalable or efficient for large-scale use and/or use in public waterways.

### SUMMARY

Some embodiments advantageously provide a system and method for removing waste materials from a body of water. In some embodiments, a system for removing waste materials from a body of water includes at least one foam fractionation device, each of the at least one foam fractionation device including: a body, the body having a first portion and a second portion opposite the first portion, the first portion including a foam collection reservoir and the second portion defining a reaction chamber, the reaction chamber being in fluid communication with the foam collection reservoir, at least a portion of the second portion being submerged in the body of water when the system is in use.

In some aspects of the embodiment, a free end of the second portion of the body is open.

In some aspects of the embodiment, the system further includes a bubble generation system, the bubble generation system being in fluid communication with the reaction chamber, the bubble generation system including an air conduit assembly having at least one nozzle.

In some aspects of the embodiment, the at least one nozzle is within the reaction chamber.

In some aspects of the embodiment, the at least one nozzle is below the open second portion when the system is in use.

In some aspects of the embodiment, the system further includes a base structure, each of the at least one foam fractionation devices being configured to be coupled to the base structure.

In some aspects of the embodiment, the base structure is configured to float on a surface of the body of water when the system is in use.

In some aspects of the embodiment, each of the at least one foam fractionation devices extends through the base structure such that at least a portion of the reaction chamber is submerged in the body of water and the foam collection reservoir is not in direct contact with the body of water when the system is in use.

In some aspects of the embodiment, the system further includes a coupling assembly configured to couple the at least one foam fractionation device to the base structure such that the at least one foam fractionation device is selectively movable relative to the base structure.

In some aspects of the embodiment, the coupling assembly includes at least one post extending from a surface of the base structure and an actuation mechanism operable to move the at least one foam fractionation device relative to the base structure and along the at least one post.

In some aspects of the embodiment, the at least one foam fractionation device includes a plurality of foam fractionation devices.

In some aspects of the embodiment, each of the at least one foam fractionation devices includes a flotation element configured to maintain a corresponding one of the at least one foam fractionation device in a position such that at least a portion of the reaction chamber is submerged in the body of water and the foam collection reservoir is not in direct contact with the body of water when the system is in use.

In some aspects of the embodiment, the flotation element is coupled to an outer surface of the reaction chamber at a location that is proximate the foam collection reservoir.

In some embodiments, a device for removing waste materials from a body of water include: a body, the body having a first portion and a second portion opposite the first portion; a foam collection reservoir, at least a portion of the foam collection reservoir being defined by the first portion; a reaction chamber, at least a portion of the reaction chamber being defined by the second portion; a foam collection cone, the foam collection cone being downstream of the reaction chamber and upstream of the foam collection reservoir; a bubble generation system, the bubble generation system being configured to deliver air bubbles within the reaction chamber; and a flotation element coupled to the body, the device floating on the body of water with at least a portion of the second portion being submerged in the body of water when the device is in use.

In some aspects of the embodiment, the reaction chamber is open to the body of water when the device is in use.

In some aspects of the embodiment, a method for removing waste materials from a body of water includes: positioning a foam fractionation device relative to the body of water, the foam fractionation device including a first portion having a foam collection reservoir and a second portion opposite the first portion and having a reaction chamber, the foam fractionation device being positioned such that at least a portion of a first portion is submerged in the body of water and at least a portion of the second portion is not in direct contact with the body of water; passing water from the body of water into the reaction chamber; and mixing air bubbles with the water within the reaction chamber.

In some aspects of the embodiment, the foam fractionation device is coupled to a base structure.

In some aspects of the embodiment, the step of positioning the foam fractionation device includes: selectively raising and/or lowering the foam fractionation device relative to the base structure.

In some aspects of the embodiment, the base structure includes a coupling assembly having at least one post extending from the base structure and an actuation mechanism, the step of selectively raising and/or lowering the foam fractionation device including: operating the actuation mechanism to move the foam fractionation device along the at least one post.

In some aspects of the embodiment, the foam fractionation device extends through the base structure.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 shows a perspective view of an exemplary embodiment of a water treatment system in accordance with the present disclosure, the water treatment system including a free-floating, partially submerged or submergible foam fractionation device;

FIG. 2 shows a perspective view of an exemplary embodiment of a water treatment system in accordance with the present disclosure, the water treatment system including a floating base structure and at least one partially submerged foam fractionation devices;

FIGS. 3 and 4 show perspective views of a further exemplary embodiment of a water treatment system in accordance with the present disclosure, the water treatment system including a floating base structure and at least one partially submerged foam fractionation device, the at least one foam fractionation device being positionable relative to the base structure;

FIG. 5 shows a perspective view of a further exemplary embodiment of a water treatment system in accordance with the present disclosure, the water treatment system including a floating base structure and at least one partially submerged foam fractional device, the at least one foam fractionation device being positionable relative to the floating base structure; and

FIG. 6 shows a simplified schematic view of an exemplary water treatment system in accordance with the present disclosure.

### DETAILED DESCRIPTION

Before describing in detail exemplary embodiments, it is noted that the embodiments reside primarily in combinations of apparatus components and steps related to foam fractionation and foam fractionation devices. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The water treatment devices, systems, and methods disclosed herein involve the aggregation, concentration, and evacuation of non-polar waste molecules from open-water systems including bacteria, environmental contaminants such as nitrogen and phosphorus, and/or sediment/turbidity caused by dredging activities, and in some cases petroleum products from spills and/or unintended release into the environment. In some embodiments, the water treatment devices, systems, and methods disclosed herein involve the aggregation, concentration, and evacuation of materials such as bacteria, most human-generated waste, and naturally occurring waste and byproduct molecules from a surrounding aquatic environment using foam fractionation. Human-generated waste molecules include many therapeutic and antibiotic products as well as products such as pesticides and industrial waste, which can accumulate in the environment and detrimentally affect ecology. Naturally occurring molecules that can be toxic to the environment include cellular debris or toxins produced during bacterial and algal blooms that are most often caused by human activities.

In its simplest form, the water treatment systems for removing waste from bodies of water disclosed herein include at least one foam fractionation device that is partially submerged, or configured to be partially submerged, in the body of water when in use. In some embodiments, the water treatment system also includes a vessel, barge, boat, floating dock, or other water-based mobile structure for supporting and deploying one or more foam fractionation devices in and/or along or proximate a body of water. In some embodiments, the water treatment system includes one or more free-floating, partially submerged foam fractionation devices. The water treatment systems disclosed herein are modular, efficiently and easily scalable, and adaptable to suit any of a variety of environment conditions, uses, and treatment area types and sizes. The unique design of the water treatment systems disclosed herein, wherein each foam fractionation device is at least partially submerged in water, increases treatment capacity and reduces system weight. As such, a foam fractionation device 12 that is included in a water treatment system 10 disclosed herein may be referred to as a floating foam fractionation device, regardless of whether it is used with a base structure, and regardless of how much of the foam fractionation device is actually submerged in the body of water being treated.

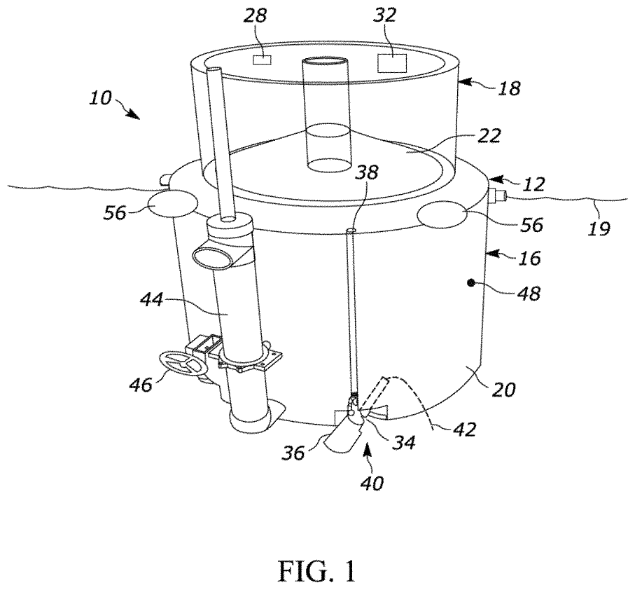

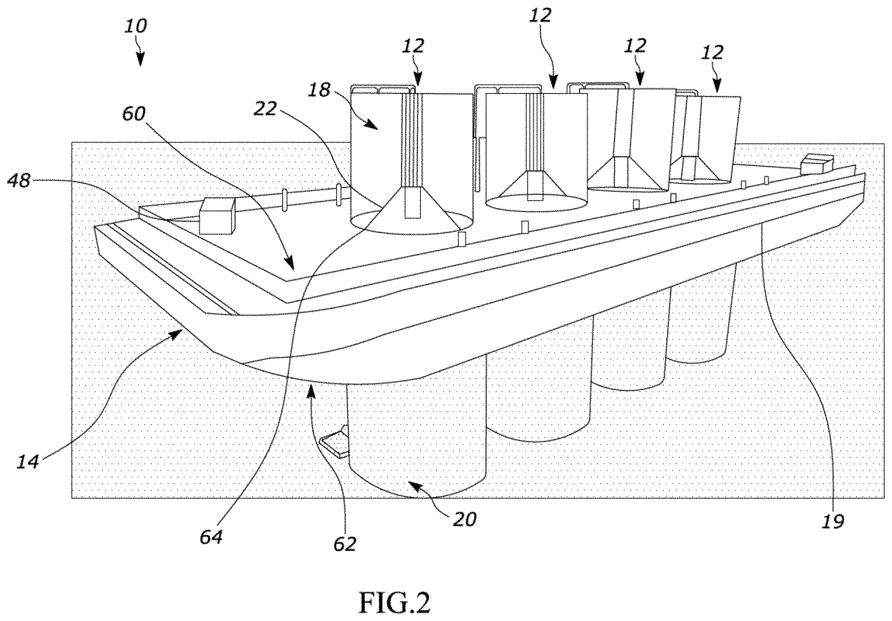

In the exemplary embodiment shown in FIGS. 2-5, the water treatment system 10 is a foam fractionation system that is includes one or more floating foam fractionation devices 12 and a base structure 14, as is configured such that at least a portion of each of one or more foam fractionation devices 12 are directly affixed to, coupled to, and/or at least partially borne or supported by a base structure 14 and at least a portion of each of the one or more foam fractionation devices 12 is submerged within the water to be treated (referred to herein as the “surrounding environment”). In the exemplary embodiment shown in FIG. 1, the water treatment system 10 is a foam fractionation system that includes one or more free-floating, partially submerged foam fractionation devices 12 that are not directly affixed to, coupled to, and/or at least partially borne or supported by a base structure 14. However, it will be understood that in some embodiments, the foam fractionation device 12 is configured or configurable for use as either a free-floating floating foam fractionation device (for example, as shown in FIG. 1) or for use at least partially borne or supported by a base structure 14 (for example, as shown in FIGS. 2-5).

In another embodiment, the water treatment system 10 includes at least one foam fractionation device 12 that is free-floating and partially submerged below the surface of the body of water (for example, as shown in FIG. 1). In another embodiment, the water treatment system 10 includes at least one foam fractionation device 12 that is affixed to, coupled to, at least partially supported by, at least partially borne by, or otherwise associated with the base structure 14 such that at least a portion of each, or at least one, foam fractionation device 12 is submerged below the surface of the body of water (for example, as shown in FIGS. 2-5). Thus, the foam fractionation devices 12 are referred to herein as being partially submerged, regardless of whether the water treatment system 10 includes a base structure 14.

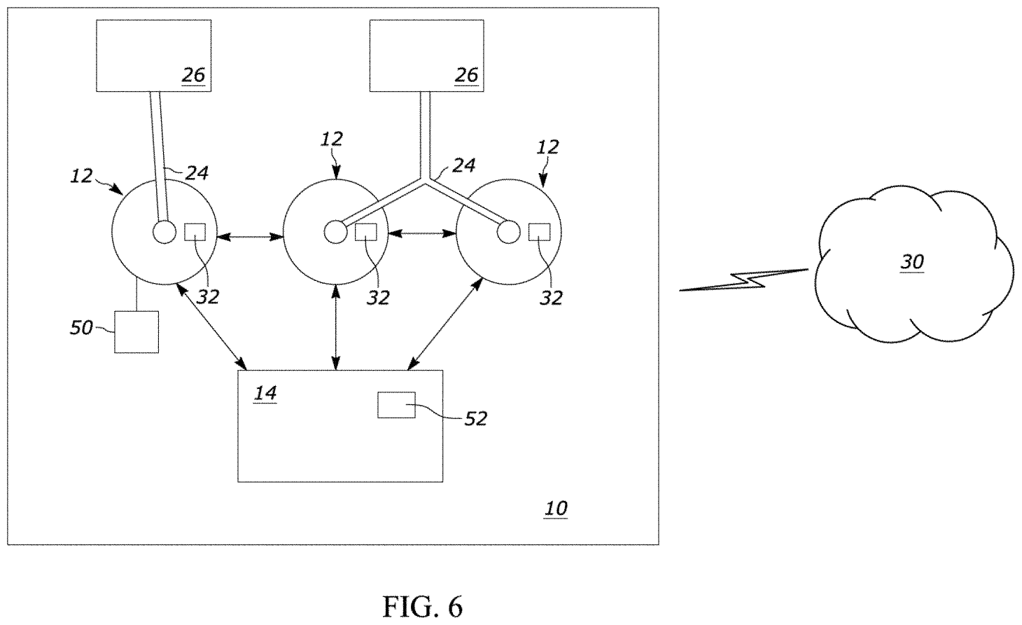

Unless otherwise noted, most components of the foam fractionation devices 12 are common to the systems of both FIG. 1 and of FIGS. 2-5. The size, shape, configuration, and/or capacity of each foam fractionation device 12 may be chosen based on factors such as the size, type, and/or conditions of the area to be treated, as well as the size, shape, and/or configuration of the base structure 14. In one non-limiting example, each foam fractionation device 12 is a commercial-/industrial-grade device. Further, FIG. 6 shows a simplified schematic view of an exemplary water treatment system 10, which system may be like that of FIG. 1 and/or of FIGS. 2-5.

Referring to FIGS. 1-5, each foam fractionation device 12 generally includes a body 16 having a first portion and a second portion opposite the first portion. The first portion includes or at least partially defines a foam collection reservoir 18 (hopper) and is configured such that at least a portion extends above the waterline 19, and the second portion includes or at least partially defines a reaction chamber 20 that is configured such that at least a portion extends downward below the waterline 19. In some embodiments, the end of the second portion opposite the first portion (the free end of the second portion) is open to allow the water of the surrounding environment to enter freely and directly into the reaction chamber 20. In other embodiments, the free end of the second portion is closed, and water is introduced into the reaction chamber 20 through the wall of the body 16 via a water intake conduit or other means. Put another way, at least a portion of the foam collection reservoir 18 remains out of the water (above the water line) and at least a portion of the reaction chamber 20 is submerged within, and contains, water from the surrounding environment when in use. In one embodiment, the reaction chamber 20 is submerged within, and completely filled with or at least partially containing, water from the surrounding environment when in use.

Referring to FIGS. 1-5, in some embodiments, the first portion of the foam fractionation device 12 includes a cone 22 within the first portion and in fluid communication with the reaction chamber 20. Although the cone 22 may be within the foam collection reservoir 18, in one embodiment the cone 22 is downstream of the reaction chamber 20 and upstream of the foam collection reservoir 18 (as the bubbles/foam flow). The cone 22 is configured such that foam (skimmate or waste from the foam fractionation device) and small air bubbles rising within the reaction chamber 20 are channeled into the cone 22, from where they continue to rise through the cone 22 and overflow into the foam collection reservoir 18. The size, shape, and/or configuration of the foam collection reservoir 18 and/or cone 22 may be chosen based on the size, shape, and/or configuration of the body 16 of the foam fractionation device 12, how often the foam and other waste will be removed from the foam collection reservoir 18, volume of air bubbles injected into the reaction chamber 20, the expected volume of foam generated per minute, and/or other considerations. Further, in some embodiments the body 16 of the foam fractionation device 12 is composed of one or more lightweight yet durable materials that can withstand or resist degradation by direct sunlight, salt water, oil and/or other floating contaminants, and other environmental stresses. In one non-limiting example, the reaction chamber 20 and/or the foam collection reservoir 18 are composed of plastic (such as polyvinylchloride (PVC), polyethylene (PE), and/or polypropylene), corrosion-resistant or coated metal, and/or other rigid or semi-rigid materials. Further, in some embodiments, the foam collection reservoir 18 is composed of a transparent or translucent material so the foam within can be seen through the walls of the foam collection reservoir 18.

Continuing to refer to FIGS. 1-5, and with reference to FIG. 6, the foam collection reservoir 18 is configured to retain a volume of foam or other waste to allow for the rapid and efficient removal of large amounts of foam and/or waste from the foam fractionation device 12 for further processing and/or disposal. In some embodiments, each foam fractionation device 12 additionally includes waste conduit 24 that is removably connected or removably connectable to a separate waste containment unit 26 (shown in FIG. 6), whether the waste containment unit 26 is dedicated to a single foam fractionation device 12 or is shared between foam fractionation devices 12. In other embodiments, a plurality of foam fractionation devices 12 are connected in series, and the last foam fractionation device 12 of the series is removably connected or removably connectable to a waste containment unit 26. However, it will be understood that the water treatment system 10 may include any number of waste containment units 26 and/or connection configurations may be used. Additionally, in some embodiments each foam fractionation device 12 (for example, the foam collection reservoir 18 and/or waste conduit) includes one or more sensors 28 to detect a maximum foam fill level and/or determine a volume of foam or fill level within the foam collection reservoir 18. In some embodiments, the sensor(s) 28 are in communication (wired, wireless, thermal, optical, infrared, chemical, mechanical etc.) with a remote computer for automatically or semi-automatically removing foam from the foam collection reservoir 18 by suction, drainage, pumping (such as by bilge pump on or within the body, or on or within a separate bilge vessel), or other means. Additionally or alternatively, the sensor(s) 28 are in direct communication with one or more suction, drainage, or pumping devices (for example, a float sensor for actuating a bilge pump and/or valve(s)) for removal of the foam into a waste containment unit. Further, in some embodiments the foam fractionation device 12 includes one or more transceivers and/or communication modules (Bluetooth®, Zigbee®, near field communication, infrared, etc.) for the transfer and/or receipt of data and signals between foam fractionation devices 12 and/or between a foam fractionation device and remote devices 30, such as computers, user interface devices, servers, networks, user radios or cellular devices, and/or the like (for example, to communication data between a foam fractionation device and a base structure, a cloud network or remote data storage device, or others). For simplicity, such data collection and transmission components and communications components are collectively referred to herein as the device control unit 32. It will be understood that alternative or additional means for monitoring and managing the level or volume of foam within the foam collection reservoir 18, as well as for the collection and organization of data (including foam composition, detected waste particles, operating hours, fault conditions, volume of foam collected, air flow volume and rate) may be used. Additionally, the sensor(s) 28 and/or device control unit 32 may be at positions or locations other than those shown in the figures.

Continuing to refer to FIGS. 1-5, in some embodiments the water treatment system 10 generally includes a means for the intake of water into at least one foam fractionation device 12 and a means for ejecting or outflowing water from the foam fractionation device(s) 12 and back into the surrounding environment. In some embodiments, each foam fractionation device 12 includes a water intake conduit 34, which may be coupled to and in fluid communication with a water pump 36 or other means for drawing in water from the surrounding environment and delivering it to the bottom of the reaction chamber 20. Additionally, in some embodiments, water is supplied from the surrounding environment to the reaction chamber 20 through the open second portion of the body 16.

Continuing to refer to FIGS. 1-5, in some embodiments, the water treatment system 10 also generally includes a means for injecting air into the foam fractionation device 12 in addition to or instead of the means for the intake of water. In some embodiments, the water treatment system 10 also generally includes a means for the intake of air from the surrounding environment and ejection or delivery of the air as air bubbles into the reaction chamber 20. For example, in some embodiments, each foam fractionation device 12 includes an air intake element 38 in addition to the water intake conduit 34 and the water pump 36. The air intake element 38 may be a hole or valve that permits the entry of air into the water intake conduit 34 as water moves quickly past the air intake element 38 through the water intake conduit 34. In this way, air is mixed with water within the water intake conduit 34 to create bubbles. Additionally or alternatively, the air intake element 38 is a conduit that is in direct fluid communication with the water pump 36 and introduces air into the water pump 36, wherein the air is mixed with water. As another example, in some embodiments the foam fractionation device 12 includes an air intake element 38 but does not include a water intake conduit 34 or water pump 36. In such an embodiment, air alone may be injected (for example, using a pump, air compressor, or other source of air or gas) into the reaction chamber 20, where it then rises through the water within the reaction chamber 20, such as in embodiments wherein the free end of the second portion of the body 16 is open. Thus, water need not be pumped or delivered into the foam fractionation device 12. However, it will be understood that the water intake conduit 34 and/or air intake element 38 may have other suitable configurations. In any embodiment, microbubbles are created within or supplied to the water intake conduit 34 and then ejected or delivered to the reaction chamber 20. Collectively, the water intake conduit 34, water pump 36, and air intake element 38 are referred to herein as the bubble generation system 40. Put simply, the bubble generation system 40 creates a large volume of small bubbles (microbubbles), in some embodiments by the Venturi effect, which are delivered to the water within the reaction chamber 20. In some embodiments, the bubble generation system 40 further includes one or more nozzles 42 and/or outlets, which may be positioned below (that is, at a level that is deeper within the water than the walls of the reaction chamber 20) and/or at any location within the reaction chamber 20, such that at least most of the small air bubbles rise within the water in the reaction chamber 20. However, it will be understood that configurations of bubble generation system 40 other than those shown and described herein may be used.

Continuing to refer to FIGS. 1-5, in one embodiment, the foam fractionation device 12 includes a water outflow conduit 44 having one or more valves 46, such as a gate valve to regulate the standing height of water in the foam collection reservoir 18. In one embodiment, the foam fractionation device 12 optionally includes one or more outlets, apertures, or other openings 48 in the wall of the reaction chamber 20 that allow water to vent from the reaction chamber 20 into the surrounding environment while retaining air bubbles within the reaction chamber 20. In one embodiment, each such opening 48 is oriented or faces downward from the outer surface of the body 16 at the reaction chamber 20 to further ensure air bubbles do not pass therethrough.

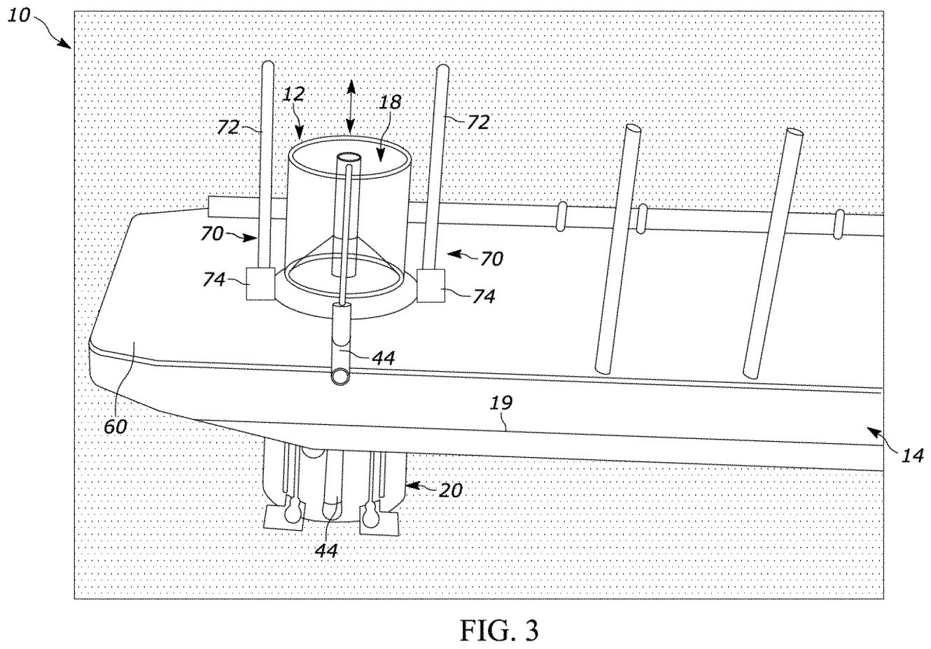

Continuing to refer to FIGS. 1-5, in some embodiments the at least one foam fractionation device 12 includes a plurality of foam fractionation devices 12. Although four foam fractionation devices 12 are shown in FIG. 2 and one foam fractionation device 12 is shown in FIGS. 3-5, it will be understood that any number may be used. Likewise, although one foam fractionation device is shown in FIG. 1, it will be understood that any number may be used, either in isolation or in fluid, mechanical, electrical, and/or data communication with each other. Further, in some embodiments, each foam fractionation device 12 is connected to a power source 50, either directly or indirectly through one or more other foam fractionation devices 12. In one embodiment, each foam fractionation device 12 includes a solar panel mounted or coupled to the body at a location above the waterline, or one or more batteries isolated from the water of the surrounding environment. Additionally or alternatively, each foam fractionation device may be coupled to a power source located on the base structure or at another location. A power source 50 is shown generally in FIG. 6; however, it will be understood that suitable configurations other than that shown may be used (for example, the power source 50 may be located on or physically attached to a foam fractionation device, shared by two or more foam fractionation devices, each foam fractionation device may include a power source 50, etc.). In some embodiments, the base structure 14 of the system of FIGS. 2-5 may also include or support other water treatment system 10 components, such as primary and/or redundant power sources, medical or emergency equipment, shade cloths or covers, reservoirs, storage containers or areas, scientific equipment, data storage devices, sensors, communications modules, steering mechanisms, anchoring mechanisms, pumps, conduits, and others. For example, in some embodiments the base structure 14 includes or supports one or more transceivers and/or communication modules (Bluetooth®, Zigbee®, near field communication, infrared, etc.) for the transfer and/or receipt of data and signals from remote devices, such as computers, user interface devices, servers, networks, user radios or cellular devices, and/or the like. For simplicity, such data collection and transmission components and communications components are collectively referred to herein as the base control unit 52. It will be understood that alternative or additional means for the collection and organization of data (including, for example, skimmate composition, detected waste particles, operating hours, fault conditions, air flow volume and rate, water pH, water temperature) may be used. Additionally or alternatively, such components may be at a remote location other than on the base structure 14. Although the foam fractionation device 12 of FIG. 1 is a free-floating foam fractionation device and does not require a base structure 14 for operation, it may be used in conjunction with a base structure 14 (such as a base structure as in FIGS. 2-5 that includes one or more foam fractionation devices) or other structure or location that includes the additional and/or optional system components discussed immediately above. For example, a free-floating, partially submerged foam fractionation device 12 as shown in FIG. 1 may be in wireless communication with a remote data storage device for data collection, may be tethered to a remote base structure to create an electrical connection (such as for supplying power to the free-floating, partially submerged foam fractionation device), or for other reasons. Thus, although the foam fractionation device(s) of the system shown in FIGS. 2-5 are directly and fixedly coupled to the base structure, the foam fractionation device(s) 12 of the water treatment system 10 shown in in any of the figures may be completely physically uncoupled from, and not in communication with, a base structure 14 (that is, completely independent from a base structure); may be directly coupled to, but located remotely from, a base structure (such as by tethering, conduits, and/or wires); or may be physically uncoupled from, but in wireless communication with, a base structure (that is, physically separate from, but in communication with, a base structure). Additionally, in some embodiments the water treatment system 10 includes a plurality of foam fractionation devices 12 in two or more configurations (for example, at least one free-floating floating foam fractionation devices 12, as shown in FIG. 1, and/or at least one foam fractionation device 12 that is fixedly or movably coupled to a base structure 14, as shown in FIGS. 2-5). Further, in some embodiments the device control unit 32 of each foam fractionation devices is in wired and/or wireless communication with the device control unit 32 of one or more other foam fractionation devices and/or is in wired and/or wireless communication with one or more base control units 52.

In general operation, the water treatment systems 10 disclosed herein and shown in FIGS. 1-5 draw water having waste molecules into one or more foam fractionation devices 12, which remove the waste molecules and eject or outflow cleaned water into the surrounding environment. In one embodiment, water to be treated is drawn into the water intake conduit 34, from where it passes into the reaction chamber 20 of at least one foam fractionation device 12. Additionally or alternatively, in some embodiments water from the surrounding environment enters the reaction chamber 20 through the open second portion of the foam fractionation device 12. The bubble generation system 40 creates small air bubbles that rise through the water within the reaction chamber 20 and bind waste materials along the way to create foam, which continues to rise and collects within the foam collection reservoir 18. Foam and other waste materials are manually collected from the foam collection reservoir 18 and/or expelled or discharged from the foam fractionation device(s) 12 through waste conduit(s) and collected in waste containment unit(s) for later processing and removal. Cleaned water is simultaneously expelled or discharged from the foam fractionation device(s) 12 through water outflow conduit(s) 44 and back into the surrounding environment. Additionally, in some embodiments a general method of use includes selectively raising and/or lowering a foam fractionation device 12 of the water treatment system 10 relative to the base structure 14 and/or waterline 19 of the body of water being treated. The water treatment system 10 is scalable to increase the effective area of water treated, such as by using additional water treatment systems and/or foam fractionation devices. The unique design of the water treatment systems 10 disclosed herein, wherein, in some embodiments, each foam fractionation device 12 includes a reaction chamber 20 that is both open to and submerged in the surrounding environment, not only allows for larger volumes of water to be treated more efficiently, but also reduces the water mass and, therefore, weight, borne by installations that are entirely above the water line. Additionally, minimizing the weight of above-water components, especially components located on a floating base structure, reduces the chance that a foam fractionation device 12 (for example, a free-floating, partially submerged foam fractionation device as shown in FIG. 1) and/or base structure 14 (for example, as shown in FIGS. 2-5) will tip over or capsize. This weight reduction also allows the water treatment system to be more scalable. For example, a base structure can support more foam fractionation devices that are at least partially submerged than foam fractionation devices that are borne above the surface of the water.

Referring now to FIG. 1, the foam fractionation device 12 is configured to float on a surface of the water, such that at least a portion extends above the waterline 19. In one embodiment, the foam fractionation device 12 includes one or more flotation elements 56 for floating or maintaining the foam fractionation device 12 in a partially submerged position when the foam fractionation device 12 is in use. For example, each flotation element 56 may be an inflated or inflatable bladder or balloon, a buoy, body composed of foam or other material that floats in water, or the like. In some embodiments, each floatation element 56 is coupled to an outer surface of the body 16 of the foam fractionation device 12. In some embodiments, each flotation element 56 is coupled to an outer surface of the reaction chamber 20, at a location that is proximate or adjacent the location at which the reaction chamber 20 meets the foam collection reservoir 18. However, the flotation element(s) 56 may be coupled to the foam fractionation device 12 in any suitable locations that ensure the flotation element(s) 56 provide sufficient buoyancy to the foam fractionation device 12 and prevent it from toppling over or otherwise enable it to maintain an upright, or at least substantially upright, position in the water. For example, in some embodiments the flotation element(s) 56 are movably positionable to adjust the height of standing water within the reaction chamber 20, such as in embodiments wherein the free end of the second portion of the body 16 is open to the surrounding environment. For example, the flotation element(s) 56 may be attached to the body 16 at a lower position to keep a greater portion of the foam fractionation device 12 out of the water and to lower the standing water height within the reaction chamber 20. Conversely, the flotation element(s) 56 may be attached to the body 16 at a higher position to submerge a greater portion of the foam fractionation device within the water and to raise the standing water height within the reaction chamber 20. In some embodiments, the foam fractionation device 12 also includes ballast or counterweight to help keep the foam fractionation device upright, even in rough waters or strong currents.

Referring now to FIGS. 2-5, and with reference to FIG. 6, in some embodiments, the base structure 14 is a mobile floating vessel such as boat, barge, floating dock, or other vessel floating within the body of water to be treated, including without limitation open waterways such as canals, rivers inlets, lakes, ponds, and the like. In other embodiments, the base structure 14 is a stationary structure, such as a pier, dock, platform, or the like positioned within or adjacent the body of water to be treated. In some embodiments, the water treatment system 10 further includes at least one waste containment unit 26, at least one intake unit, an outflow unit (which may be separate from or integrated with an intake unit), at least one floating surface skimmer, and/or other system components. The water treatment system 10 is scalable in that any number of base structures 14, foam fractionation devices 12, and/or other system components may be used, depending on factors such as the size, type, and/or conditions of the area to be treated. It will also be understood that, in some embodiments, such as when used in a narrow canal, reservoir, channel, irrigation system, or the like, the base structure 14 may be towable behind or pushed in front of another mobile vessel, such as a boat, skiff, barge, raft, or a land vehicle such as a truck, tractor, trailer, terrestrial barge or platform having wheels, or the like. Thus, in some embodiments, a terrestrial vehicle may move along the land adjacent to the body of water and tow or move the foam fractionation device(s) 12 to treat the water as it moves.

Continuing to refer to FIGS. 2-5, in one embodiment the base structure 14 includes a motor, engine with propeller, or other means for propulsion, which may be used to position the base structure 14 and/or water treatment system 10 at the desired treatment site and/or to move the foam fractionation device(s) 12 along or adjacent to the body of water. For simplicity, regardless of the configuration of the vessel or vehicle used, any mobile aquatic and/or terrestrial structures and/or vehicles used to support and move the foam fractionation device(s) 12 are collectively referred to herein as a base structure 14.

Continuing to refer to FIGS. 2-5, in one embodiment the foam collection reservoir 18 at the first portion extends above an upper surface 60 of the base structure 14 and/or within the base structure 14 (such as at least partially within the hull or deck) and is not in direct contact with the water of the surrounding environment (or at least a portion of the first portion is not in direct contact with the water of the surrounding environment), and the reaction chamber 20 at the second portion is configured to extend below a bottom or lower surface 62 of the base structure 14, into the water being treated. Put another way, in one embodiment, each foam fractionation device 12 extends through the base structure 14 in a direction that is orthogonal, or at least substantially orthogonal, to the waterline 19 and/or a surface of the base structure 14 when mounted to the base structure 14. In one embodiment, the water treatment system 10 includes a plurality of foam fractionation devices 12 that are coupled to and extend through the base structure 14. In some embodiments, each foam fractionation device is inserted through and positioned within a hole or opening 64 through the base structure 14. In other embodiments, the components of each foam fractionation device 12 are installed separately. For example, in some embodiments the foam collection reservoir 18 is coupled to an upper surface 60 of the base structure 14 (and/or to or within an upper portion of an opening 64) and the reaction chamber 20 is coupled to a bottom surface 62 of the base structure (and/or to or within a lower portion of an opening 64), and the foam collection reservoir 18 and reaction chamber 29 are put into fluid communication with each other, such as by coupling the two pieces together, by coupling each piece to a sleeve or insert within the base structure 14, or by other means for ensuring fluid communication between the foam collection reservoir 18 and reaction chamber 20 and for fluidly isolating the foam fractionation device 12 from the rest of the base structure 14. In one embodiment, at least a portion of the foam collection reservoir 18 at the first portion extends above the waterline 19 and is not in contact with the water of the surrounding environment, and at least a portion of the reaction chamber 20 at the second portion is configured to extend below the waterline 19 such that at least a portion of the reaction chamber 20 is within the water to be treated.

Referring to FIG. 2, in some embodiments each foam fractionation device 12 is coupled to the base structure in a fixed position relative to the base structure 14. For example, each foam fractionation device 12 may be mounted within an opening or aperture 64 within the base structure 14 such that the foam fractionation device 12 does not or cannot move within the opening or aperture 64, and the foam collection reservoir 18 and reaction chamber 20 remain at same positions relative to the base structure 14 (such as relative to a deck or upper surface 60 of the base structure 14 and/or relative to a hull or lower surface 62 of the base structure 14). In some non-limiting examples, each foam fractionation device 12 may be secured to the base structure 14 with screws, bolts, pins, latches, fittings, welding, chemical welding, chemical adhesives, friction fit, or by other suitable means.

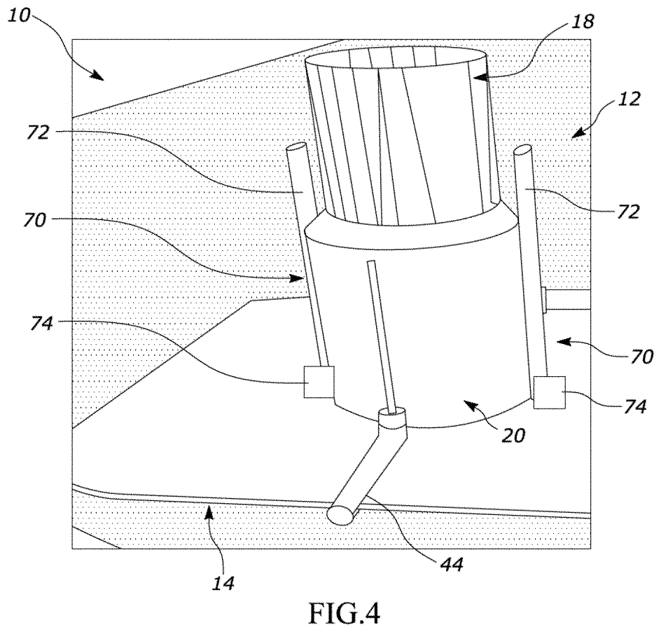

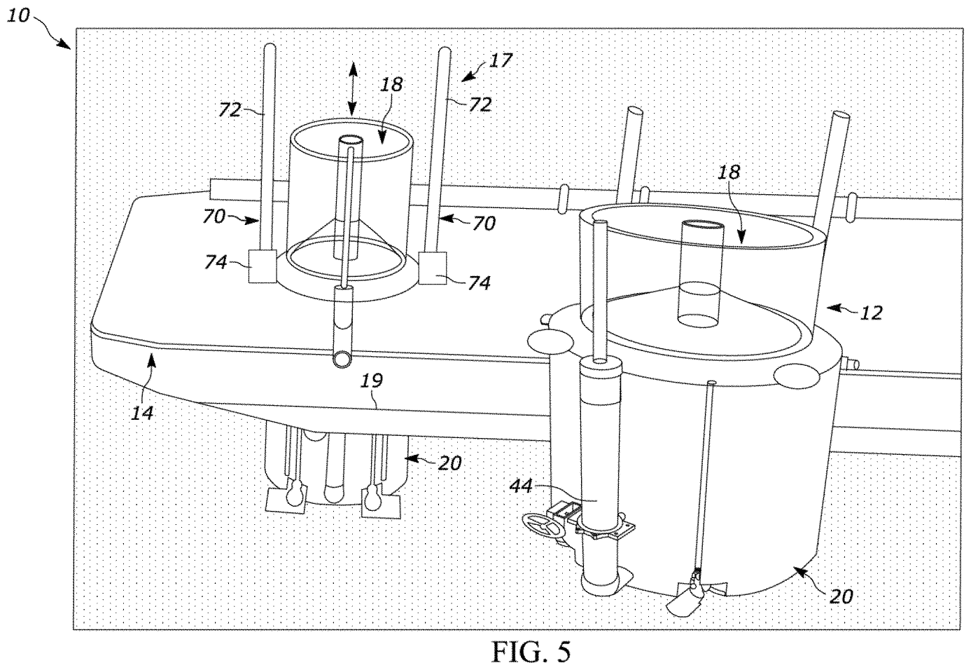

Referring to FIGS. 3-5, in some embodiments the water treatment system 10 includes at least one foam fractionation device 12 that is movably coupled (that is, positionable) relative to the base structure 14. In one embodiment, each foam fractionation device 12 is movably coupled to the base structure 14 such that the foam fractionation device 12 may be selectively raised and lowered relative to the base structure 14. In one non-limiting example, the foam fractionation device 12 is movably coupled to the base structure 14, such as within an opening or aperture 64 in the base structure 14, so that it may be raised and lowered through the base structure 14 in a direction that is orthogonal, or at least substantially orthogonal to, the waterline 19 and/or a surface of the base structure 14 (as shown in FIGS. 3-4). In another non-limiting example, the foam fractionation device 12 is movably coupled to the base structure 14, such as alongside the base structure 14, so that it may be raised and lowered next to the base structure 14 in a direction that is orthogonal, or at least substantially orthogonal to, the waterline 19 and/or a surface of the base structure 14 (as shown in FIG. 5).

In currently known systems wherein a foam fractionation device is resting on top of a base structure (such as a barge, skiff, boat, etc.), a significant amount of energy is needed to pump water from the surrounding environment upward and into the reaction chamber. In the water treatment systems 10 disclosed herein, however (such as those shown in FIGS. 3-5), the reaction chamber 20 is configured to be positioned at least partially within the water to be treated. Consequently, water from the surrounding environment does not need to be pumped upward against gravity, but can instead be pumped laterally, or at least substantially laterally, from the surrounding environment into the reaction chamber 20. To accomplish this, it may be desirable to selectively lower the foam fractionation device 12 to: position it at least partially within the body of water to be treated during use; raise the foam fractionation device 12 when the base structure 14 is in transit; to remove the foam fractionation device 12 for replacement, repair, and/or maintenance; to facilitate coupling and positioning of the foam fractionation device 12 to a stationary or terrestrial base structure such as a pier, dock, or trailer for use and/or transportation; to adjust the position of the foam fractionation device 12 during use to compensate for water, skimmate, and fluids within the foam collection reservoir 18; and/or to place the foam fractionation device 12 in a position that optimal for efficient use and to reduce energy requirements. Additionally, in some embodiments air alone is pumped into the reaction chamber 20, which also eliminates the need to move water against gravity.

Continuing to refer to FIGS. 3-5, in some embodiments the water treatment system 10 includes at least one coupling assembly 70 for coupling each foam fractionation device 12 to the base structure 14. In one embodiment, the at least one coupling assembly 70 incudes one or more posts or guides 72 at a location proximate or adjacent to the location of the foam fractionation device 12. In one non-limiting example, each post or guide 72 extends upward from an upper surface 60 of the base structure 14, along a direction in which the foam fractionation device 12 may be raised relative to the base structure 14 (for example, as indicated by the double-headed arrow in FIGS. 3 and 5). In one method of use, each foam fractionation device 12 is controllably raised and lowered along a plurality of posts 72 extending from the base structure 14, with movement of the foam fractionation device 12 being limited, controlled, or guided by the coupling assembly 70 in general and/or posts 72 in particular. In some embodiments, movement of the foam fractionation device 12 is limited by the posts 72 to movement along a single axis.

Referring to FIGS. 3 and 4, in one embodiment each coupling assembly 70 further includes an actuation mechanism 74 for effectuating movement (for example, raising and lowering) a foam fractionation device 12. In some embodiments, the actuation mechanism 74 includes a motor, gear box, and power source to cause automatic or semi-automatic movement or repositioning of the foam fractionation device 12. However, it will be understood that the actuation mechanism 74 also may include additional components, and/or may be configured for manual operation with or without the need for a power source. For example, the actuation mechanism 74 may be or include a winch, a hoist, block and tackle, a jack, a ratchet, a pulley, a windlass, or the like. Additionally, each foam fractionation device 12 may include complementary components that are configured to couple the foam fractionation device 12 to the coupling assembly 70. In some embodiments, an outer surface of the foam fractionation device 12, such as an outer surface of the reaction chamber 20, includes one or more hooks, chains, eye plates, handles, ropes, ratchet straps, pins, screws, bolts, cables, and/or other components for engaging with the actuation mechanism 74 and facilitating controlled movement of the foam fractionation device 12.

Continuing to refer to FIGS. 3 and 4, the foam fractionation device 12 is shown in a lowered position in FIG. 3 and is shown in a raised position in FIG. 4. In some embodiments, the water outflow conduit 44 is mounted on or level with a surface of the base structure 14 and positioned to direct outflow water back into the surrounding environment.

Referring to FIG. 5, in some embodiments the water treatment system 10 is configured substantially similar to that shown and described in FIGS. 3-4, except that the foam fractionation device 12 is configured to be selectively raised and/or lowered alongside the base structure 14 (for example, over the port, starboard, aft, or rear side of the base structure) instead of through the hull of the base structure as shown in FIGS. 3 and 4. Otherwise, in some embodiments the water treatment system 10, including each foam fractionation device 12, coupling assembly 70, base structure 14, and/or components thereof are the same or substantially the same as that shown and described in FIGS. 3 and 4.

### EXEMPLARY EMBODIMENTS

Some embodiments advantageously provide a system and method for removing waste materials from a body of water. In one embodiment, a system for removing waste materials from a body of water comprises at least one partially submerged foam fractionation device, each of the at least one partially submerged foam fractionation device including: a body, the body having a first portion and a second portion opposite the first portion, the first portion including a hopper and the second portion being open and defining a reaction chamber, the reaction chamber being in fluid communication with the hopper; and a bubble generation system in fluid communication with the reaction chamber, at least a portion of the second portion being submerged in the body of water when the system is in use.

In one aspect of the embodiment, the bubble generation system includes an air conduit assembly having at least one nozzle.

In one aspect of the embodiment, the at least one nozzle is within the reaction chamber.

In one aspect of the embodiment, the at least one nozzle is below the open second portion when the system is in use.

In one aspect of the embodiment, the system further comprises a base structure, each of the at least one partially submerged foam fractionation devices being coupled to the base structure.

In one aspect of the embodiment, the base structure is configured to float on a surface of the body of water when the system is in use.

In one aspect of the embodiment, the base structure is one of a boat, a skiff, a barge, a raft, a ship, and a floating dock.

In one aspect of the embodiment, each of the at least one partially submerged foam fractionation devices extends through the base structure such that the reaction chamber is submerged in the body of water and the hopper is not in direct contact with the body of water when the system is in use.

In one aspect of the embodiment, the at least one partially submerged foam fractionation device includes a plurality of partially submerged foam fractionation devices.

In one aspect of the embodiment, each of the at least one partially submerged foam fractionation devices includes a flotation element configured to maintain the at least one partially submerged foam fractionation device in a position such that the reaction chamber is submerged in the fluid and the hopper is not in contact with the fluid when the system is in use.

In one aspect of the embodiment, the flotation element is coupled to an outer surface of the reaction chamber at a location that is proximate the hopper.

In one embodiment, device for removing waste materials from a body of water comprises: a body, the body having a first portion and a second portion opposite the first portion; a foam collection reservoir, at least a portion of the foam collection reservoir being defined by the first portion; a reaction chamber, at least a portion of the reaction chamber being defined by the second portion; a foam collection cone, the foam collection cone being downstream of the reaction chamber and upstream of the foam collection reservoir; a bubble generation system, the bubble generation system being configured to deliver air bubbles within the reaction chamber; and a flotation element coupled to the body, the device floating on the body of water with at least a portion of the second portion being submerged in the body of water when the device is in use.

In one aspect of the embodiment, the floatation element is coupled to an outer surface of the reaction chamber at a location that is proximate the foam collection reservoir.

In one aspect of the embodiment, the reaction chamber is open to the body of water when the device is in use.

In one aspect of the embodiment, the reaction chamber is completely filled with water from the body of water when the device is in use.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

As used herein, “and/or” means “and” or “or”. For example, “A and/or B” means “A, B, or both A and B” and “A, B, C, and/or D” means “A, B, C, D, or a combination thereof” and said “A, B, C, D, or a combination thereof” means any subset of A, B, C, and D, for example, a single member subset (e.g., A or B or C or D), a two-member subset (e.g., A and B; A and C; etc.), or a three-member subset (e.g., A, B, and C; or A, B, and D; etc.), or all four members (e.g., A, B, C, and D).

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A system for removing waste materials from a body of water, the system comprising at least one foam fractionation device, each of the at least one foam fractionation device including:
a body, the body having a first portion and a second portion opposite the first portion, the first portion including a foam collection reservoir and the second portion defining a reaction chamber, the reaction chamber being in fluid communication with the foam collection reservoir,
at least a portion of the second portion being submerged in the body of water when the system is in use.

2. The system of claim 1, wherein a free end of the second portion of the body is open.

3. The system of claim 2, further comprising a bubble generation system, the bubble generation system being in fluid communication with the reaction chamber, the bubble generation system including an air conduit assembly having at least one nozzle.

4. The system of claim 3, wherein the at least one nozzle is within the reaction chamber.

5. The system of claim 3, wherein the at least one nozzle is below the open second portion when the system is in use.

6. The system of claim 1, further comprising a base structure, each of the at least one foam fractionation devices being configured to be coupled to the base structure.

7. The system of claim 6, wherein the base structure is configured to float on a surface of the body of water when the system is in use.

8. The system of claim 7, wherein each of the at least one foam fractionation devices extends through the base structure such that at least a portion of the reaction chamber is submerged in the body of water and the foam collection reservoir is not in direct contact with the body of water when the system is in use.

9. The system of claim 7, further comprising a coupling assembly configured to couple the at least one foam fractionation device to the base structure such that the at least one foam fractionation device is selectively movable relative to the base structure.

10. The system of claim 9, wherein the coupling assembly includes at least one post extending from a surface of the base structure and an actuation mechanism operable to move the at least one foam fractionation device relative to the base structure and along the at least one post.

11. The system of claim 1, wherein the at least one foam fractionation device includes a plurality of foam fractionation devices.

12. The system of claim 1, wherein each of the at least one foam fractionation devices includes a flotation element configured to maintain a corresponding one of the at least one foam fractionation device in a position such that at least a portion of the reaction chamber is submerged in the body of water and the foam collection reservoir is not in direct contact with the body of water when the system is in use.

13. The system of water of claim 12, wherein the flotation element is coupled to an outer surface of the reaction chamber at a location that is proximate the foam collection reservoir.

14. A device for removing waste materials from a body of water, the device comprising:
a body, the body having a first portion and a second portion opposite the first portion;
a foam collection reservoir, at least a portion of the foam collection reservoir being defined by the first portion;
a reaction chamber, at least a portion of the reaction chamber being defined by the second portion;
a foam collection cone, the foam collection cone being downstream of the reaction chamber and upstream of the foam collection reservoir;
a bubble generation system, the bubble generation system being configured to deliver air bubbles within the reaction chamber; and
a flotation element coupled to the body,
the device floating on the body of water with at least a portion of the second portion being submerged in the body of water when the device is in use.

15. The device of claim 14, wherein the reaction chamber is open to the body of water when the device is in use.

16. A method for removing waste materials from a body of water, the method comprising:
positioning a foam fractionation device relative to the body of water, the foam fractionation device including a first portion having a foam collection reservoir and a second portion opposite the first portion and having a reaction chamber, the foam fractionation device being positioned such that at least a portion of a first portion is submerged in the body of water and at least a portion of the second portion is not in direct contact with the body of water;
passing water from the body of water into the reaction chamber; and
mixing air bubbles with the water within the reaction chamber.

17. The method of claim 16, wherein the foam fractionation device is coupled to a base structure.

18. The method of claim 17, wherein the step of positioning the foam fractionation device includes:
selectively raising and/or lowering the foam fractionation device relative to the base structure.

19. The method of claim 18, wherein the base structure includes a coupling assembly having at least one post extending from the base structure and an actuation mechanism, the step of selectively raising and/or lowering the foam fractionation device including:
operating the actuation mechanism to move the foam fractionation device along the at least one post.

20. The method of claim 17, wherein the foam fractionation device extends through the base structure.
